(19) United States
(12) Patent Application Publication
(10) Pub. No.: US 2005/0289388 A1
(43) Pub. Date: Dec. 29, 2005

(54) Dynamic cluster configuration in an on-demand environment

(75) Inventors: Elizabeth Ann Black-Ziegelbein, Austin, TX (US); Thomas R. Gissel, Cary, NC (US); Brian Keith Martin, Cary, NC (US); Qinhua Wang, Pittsburg, PA (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(73) Assignee: International Business Machines Corporation, Armonk, NY (US)

(21) Appl. No.: 10/874,494

(22) Filed: Jun. 23, 2004

(51) Int. Cl. G06F 11/00

(52) U.S. Cl. 714/7

(57) ABSTRACT

Methods, systems, and media are disclosed for clustering. One embodiment includes receiving, by a configuration manager server, a request to create a dynamic cluster member for a dynamic cluster, wherein the request is for work load balancing and the dynamic cluster member is a process. Further, the embodiment includes parameterizing, by the configuration manager server, to create parameters for a dynamic cluster server template based on configuration files of nodes within a nodegroup. The configuration files and the dynamic cluster server template are stored in a central location associated with the configuration manager server. The embodiment also includes populating, by the configuration manager server, the parameters of the dynamic cluster server template with values associated with the nodes. Finally, the embodiment includes instantiating, by the configuration manager server, the process, associated with at least one of the nodes, from the dynamic cluster server template, thereby, creating the dynamic cluster member.

### FIELD OF INVENTION

The invention generally relates to configuring clusters. More particularly, the invention relates to methods, systems, and media for configuring clusters at run time and in an on-demand, networked, computer environment by creating a “dynamic cluster” member, which eases the tedious administrative task of today's static configuration of clusters.

### BACKGROUND

Today, businesses and organizations are becoming critically dependent on their information technology resources. In connection with this dependency, businesses continually seek out means of assessing and controlling costs, which, for example, include alternatives to outright purchases of computer resources necessary to access and use their information. On example alternative is leasing of computer resources, such as servers, databases, and software suites. Leasing, as compared to purchasing, of the many resources a business needs to effectively compete in the marketplace may provide a business with more favorable tax advantages, smaller outlays of cash, and less required storage space to house these resources, which may only require occasional rather than regular use by a business. In addition, leasing by an on-demand basis, for example, may also provide businesses with the capability to financially plan, grow, and afford only the amount and type of resources it currently needs to access and use its information. Those current needs fluctuate because a business inevitably incurs peaks and valleys in day-to-day operations due to increased loads for seasonal, period end, or special promotions. As a result, any unused, i.e., excess, resources owned by a business are avoidable costs through leasing that otherwise unnecessarily burden the financial well-being of a business. In addition, any resources, such as computing power and updated software programs, that a business does not own and it ordinarily needs or occasionally needs to meet peak performance requirements, also translates into possible, avoidable financial loss if the business leased such resources.

In addition to how a business can affordably access and use resources it needs, by, for example, leasing such resources on demand, the resources, themselves, must provide continuous availability without fail; otherwise, outages may render serious business implications including loss of revenue that could be so serious that results in permanently closing a business. To allay such discontinuous availability, clustering is often employed to enable a system provider to balance variable work loads to efficiently use its underlying component systems.

A cluster is a collection of one or more complete systems, having associated processes, that work together to provide a single, unified computing capability. The perspective from the end user, such as a business, is that the cluster operates as through it were a single system. Work can be disturbed across multiple systems within the cluster. Any single outage, whether planned or unplanned, in the cluster will not disrupt the services provided to the end user. That is, end user services can be relocated from system to system within the cluster in a relatively transparent fashion.

Today, before taking advantage of the dependable accessibility benefits permitted by clustering technology, a cluster requires configuration, a task possibly undertaken by a system administrator. Configuring a cluster requires a predetermination of what are the cluster member configurations and on which nodes, i.e., application server middleware installations, these configurations reside. As a result, today, cluster configuration is basically static, and, even presuming that the static configuration is error free, which may not be true, configuring still requires a system administrator to outlay significant time and planning. This time and planning is costly, and even more costly if errors exist requiring even more time and planning to correct an error in cluster configuration.

A need, therefore, exists, for methods, systems, and media for configuring clusters in on demand environments that reduces both likelihood of error associated with manual configuration and the necessary time and planning required for cluster configuration.

### SUMMARY OF THE INVENTION

Embodiments of the invention generally provide methods, systems, and media for clustering. In one embodiment, the method generally includes receiving, by a configuration manager server, a request to create a dynamic cluster member for a dynamic cluster, wherein the request is for work load balancing and the dynamic cluster member is a process. Further, the method includes parameterizing, by the configuration manager server, to create parameters for a dynamic cluster server template based on configuration files of nodes within a nodegroup, wherein the configuration files and the dynamic cluster server template are stored in a central location associated with the configuration manager server. Further still, the method includes populating, by the configuration manager server, the parameters of the dynamic cluster server template with values associated with the nodes, and instantiating, by the configuration manager server, the process, associated with at least one of the nodes, from the dynamic cluster server template after the populating, thereby, creating the dynamic cluster member.

In another embodiment, the invention provides a system for clustering. The system generally includes a receiver in communication with a configuration manager server for receiving a request to create a dynamic cluster member for a dynamic cluster, wherein the request is for work load balancing and the dynamic cluster member is a process. Further, the system includes memory in a centralized location in communication with the configuration manager server, and a dynamic cluster server template stored in the memory and associated with the configuration manager server. Further still, the system includes a parameterization module in communication with the configuration manager server for parameterizing the dynamic cluster server template based on configuration files of nodes within a nodegroup, wherein the configuration files are stored in the memory. Yet further, the system includes a population module in communication with the configuration manager server for populating, the parameters of the dynamic cluster server template with values associated with the nodes. The system also includes an instantiation module in communication with the configuration manager server for instantiating, by the configuration manager server, the process, associated with at least one of the nodes, from the dynamic cluster server template after execution by the population module, whereby, the dynamic cluster member is created.

In yet another embodiment, the invention provides a machine-accessible medium containing instructions for clustering, which when executed by a machine, cause the machine to perform operations. The instructions generally include operations for receiving, by a configuration manager server, a request to create a dynamic cluster member for a dynamic cluster, wherein the request is for work load balancing and the dynamic cluster member is a process. The instructions further include operations for parameterizing, by the configuration manager server, to create parameters for a dynamic cluster server template based on configuration files of nodes within a nodegroup, wherein the configuration files and the dynamic cluster server template are stored in a central location associated with the configuration manager server. Further, the instructions generally include operations for populating, by the configuration manager server, the parameters of the dynamic cluster server template with values associated with the nodes. Further still, the instructions generally include operations for instantiating, by the configuration manager server, the process, associated with at least one of the nodes, from the dynamic cluster server template after the populating, thereby, creating the dynamic cluster member.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a cluster and related terminology and concepts in accordance with the disclosed invention.

FIG. 2 depicts an example embodiment of a system for clustering in accordance with the disclosed invention.

FIG. 3 depicts an example embodiment of a flowchart for clustering in accordance with the disclosed invention.

FIG. 4 depicts an example embodiment of a computer systems capable of use for clustering in accordance with the disclosed invention.

### DETAILED DESCRIPTION OF THE EMBODIMENTS

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, systems, methods, and media for clustering are contemplated. Embodiments include: (1) a networked system of computer systems, such as IBM's AS/400® systems having, for example, installations of IBM's WebSphere® application server middleware on each node of these systems; (2) a pool of resources, which are any physical or logical entities, such as databases, files, applications, devices, and so on; and (3) processes, such as WebServer® or singleton application processes, associated with at least one node of a computer system. Also by network communication, a user may send a request to demand access and use of the computer systems and resources in the networked system, wherein the networked system receives and interprets the request in terms of a request for work load balancing on the networked system and the creation of a cluster member for a dynamic cluster. To effectuate this request on the networked system, enabling software and/or hardware dynamically configures and creates a dynamic cluster member on the networked system. More specifically, software and/or hardware logic associated with the networked system configures a dynamic cluster by parameterizing a dynamic cluster server template (“DCST”) with parameters based on the centrally stored configuration files of nodes in a pre-configured nodegroup, wherein a nodegroup is a collection of nodes linked together for a common purpose. The pre-configured nodegroup may include assigning a nodetype to nodes within a nodegroup in order to uniquely identify differences that exist between nodes in the nodegroup, i.e., in heterogeneous nodegroups. After parameterization, the DCST is populated with values associated with nodes in a nodegroup, and at least one process associated with one or more nodes is instantiated from the DCST to result in creation of a dynamic cluster for balancing and performing the work load.

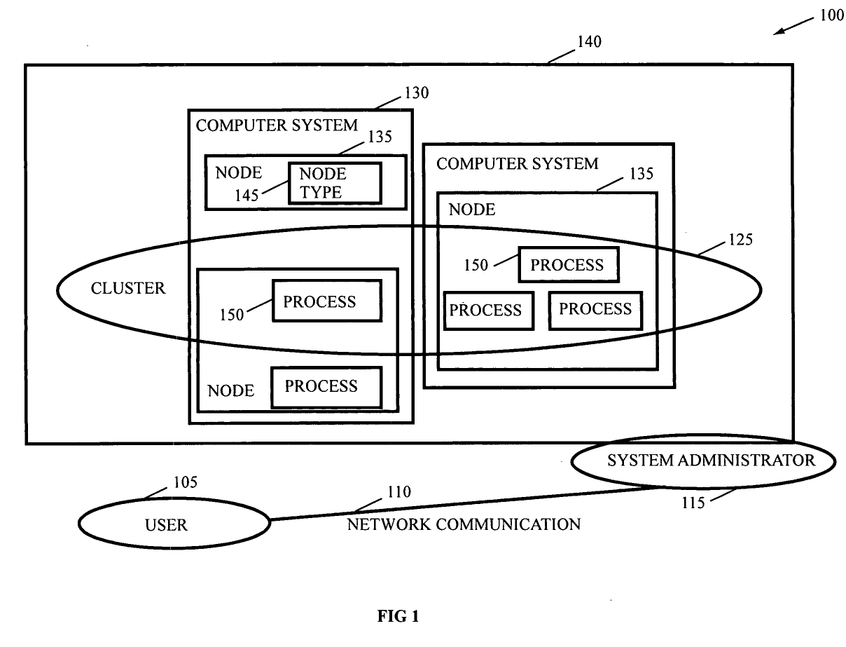

Turning now to FIG. 1, a system 100 is depicted showing an overview of some aspects of the invention. Although a cluster may be thought of in terms of machines, from a software perspective, a cluster may also be thought of as processes, whether running or not, on the machines; the software perspective controls in this disclosure. In FIG. 1, the system 100 shows a user 105, such as a computer system used by a business and capable of sending a request for use and access of computer systems, resources, and, most importantly, processes associated with the computer systems, by network communication 110 to a system administrator 115. The system administrator 115 is, for example, one or more computer systems, optionally operated by a person, capable of configuring a dynamic cluster 125 to perform and balance the work load associated with the user's 105 request. The system administrator 115, in network communication with the computer systems, processes, etc. of a cell, configures the dynamic cluster 125 with one or more processes 150 (i.e., dynamic cluster member(s)) associated with one or more computer systems 130. Each computer system 130 has at least one node 135, and each node 135 has an installation of application server middleware, such as WebSphere®. Further, the configured dynamic cluster 125 includes at least two nodes 135 already pre-configured into a nodegroup 140, which contain nodes 135 linked together for a common purpose. Further still, the nodes 135 may also have associated resources, such as databases, files, applications, and printers. Although only one nodegroup 140 is depicted in FIG. 1 as being part of the dynamic cluster 125, more than one nodegroup 140 may be part of the dynamic cluster 125. In addition, node 135 in a nodegroup 140 is further identifiable by nodetype 145, which is a characteristic of a particular node 135 such as its hardware and software capabilities, amount of memory, and processing power.

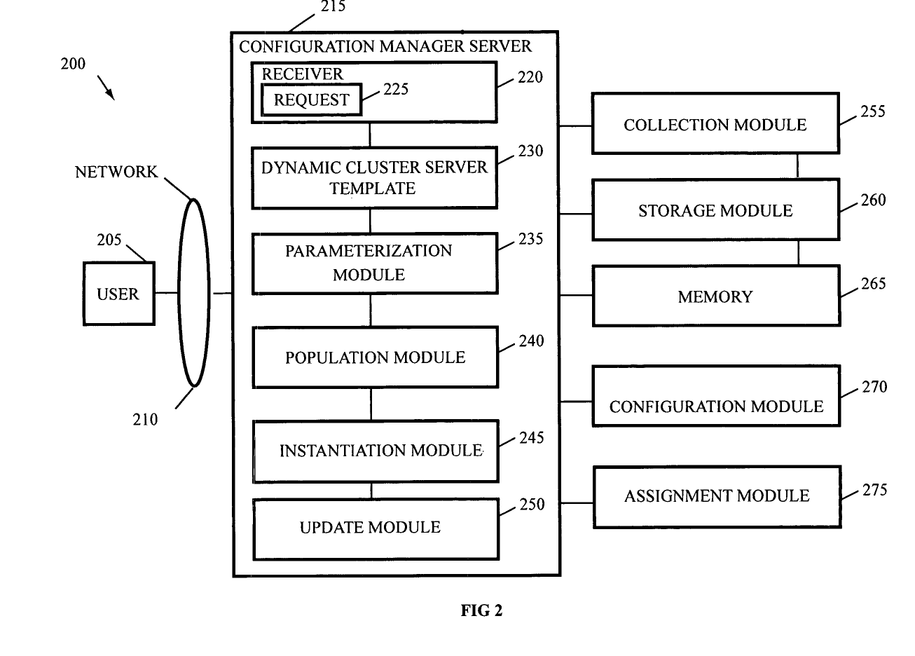

Turning to FIG. 2, details of the FIG. 1's overview are now disclosed. FIG. 2 depicts a system 200 for a configuration manager server 215 associated, for example, with a system administrator's computer system, which is not depicted in FIG. 2, to handle a request 225 received from a user 205 by network 210 communication. For example, the network 210 communication is wired or wireless, and may also be part of a LAN, WAN, or MAN. The request 225, itself, is a work load that a user 205 seeks to be performed by a web service provider, for example, that allows its host of powerful computer systems, having processes, to be accessed and used upon a user's 205 demand. Such processes include, for example, a WebServer® or a singleton application process.

Enabled by hardware and/or software, the configuration manager server 215 has a receiver 220 for receiving the request 225, which the configuration manager server 215, through further enabling logic, efficiently balances by creating at least one dynamic cluster member, i.e., a process, for inclusion in a dynamic cluster to handle the work load associated with performing the user's 205 request 225.

Before the system 200 processes the request 225 to create a dynamic cluster member for a dynamic cluster, the system 200 includes a configuration module 270 for configuring processes associated with the nodes into nodegroups, wherein the configuration module 270, itself, is optionally either associated with the configuration manager server 215, as depicted, or an integral part of the configuration manager server 215. A nodegroup is a collection of nodes, each of which have an installation of application server middleware, such as WebSphere®, that are grouped together for some common purpose. The configuration module 270, enabled by coded logic in software and/or reduced to hardware, permits a system administrator, for example, to pre-configure the nodes into nodegroups before the configuration manager server 215 results in the formation of a dynamic cluster to process the work load of the request 225.

Also prior to the system 200 processing the request 225, the system 200 also includes an assignment module 275, enabled by encoded logic and/or logic reduced to hardware, for assigning the nodes in each nodegroup with nodetypes, which is particularly useful for identifying a node among nodes in heterogeneous nodegroups. Nodetypes are characteristics of nodes that have values identifying, for example, a node's processing power or memory size. The assignment module 275, itself, is optionally integrated into or associated with the configuration manager server 215.

Returning now to the request 225 received by the receiver 220, further logic associated with the configuration manager server 215 provides for and permits a parameterization module 235 to parameterize a centralized template, referred to as a “dynamic cluster server template” 230 that is also associated with the configuration manager server 215. The parameterization module 235 parameterizes the dynamic cluster server template 230 based on configuration files for the nodes, including at least one of their processes, into a nodegroup. However, prior to execution by the parameterization module 235, and rather than these configuration files residing on each and every node, a collection module 255, enabled by further logic optionally associated with or integrated into the configuration manager server 215, gathers all of the configuration files for each of the nodes in a nodegroup, and a storage module 260, also enabled by logic and optionally associated with or integrated into the configuration manager server 215, stores the gathered configuration files for the nodes in a nodegroup in memory 265, having a centralized location easily accessed by the configuration manager server 215. As a result of this centralized memory, the configuration manager server 215, through the parameterization module 235, may swiftly parameterize the dynamic cluster server template 230 with the already gathered and stored configuration files of the nodes in the one or more nodegroups that will perform and balance the work load associated with the request 225 in the yet to be created dynamic cluster.

After execution by the parameterization module 235, FIG. 2 shows a population module 240, enabled by further logic, for populating the parameterized dynamic cluster server template 230. The population module 240 permits enabling logic for altering or determining which particular parameters are to be populated with values, such as nodetype, as well as whether default or overridden values with a variable at a particular scope, such as nodetype, node, cell, etc., will populate the parameterized dynamic cluster server template 230.

After the population module 240 populates the desired or default parameters of the dynamic cluster server template 230, the instantiation module 245 associated (i.e., in communication) with the population module 240 instantiates the process, associated with at least one of the nodes, from the populated dynamic cluster server template 230 to tell such at least one process that it is a cluster member of a dynamic cluster to perform the work load associated with the request 205. That is, the instantiation module 245 is the final component of the system 200 that results in creation of a dynamic cluster member for a dynamic cluster by impressing the populated dynamic cluster server template 230 on a process associated with a node in the nodegroup.

Further and optional logic is associated with the update module 250, which is also associated or integrally incorporated into the configuration manager server 215. The update module 250 re-instantiates another process, associated with at least one of the nodes, from the dynamic cluster server template 230 after altering, perhaps by a system administrator's choice, the parameters to be populated with values in the dynamic cluster server template 230.

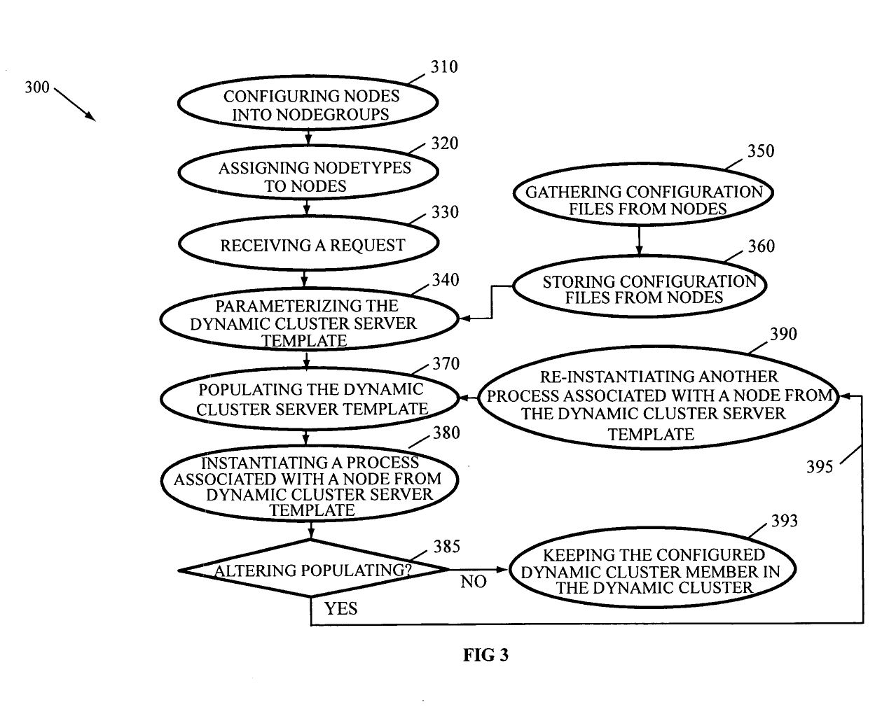

Turning now to FIG. 3, another aspect of the invention is disclosed. In particular, an embodiment of a flowchart 300 for clustering is disclosed. Flowchart 300 is for a system, such as systems 100 and 200, as shown in FIG. 1 and FIG. 2.

Flowchart 300 begins with two pre-configuration steps, namely configuring 310 a web service provider's nodes, each of which has at least one process, into nodegroups and assigning 320 such nodes in nodegroups with nodetypes. Configuring 310, which is usually pre-configuring, of the nodes into nodegroups is enabled by associated logic, wherein a nodegroup is a group of computer systems having nodes on each computer system that are linked together to perform some common purpose. As an example, a web service provider's system administrator may configure 310 the nodes, each of which have at least one process, into nodegroups, whereby the commonality for linking these nodes into a nodegroup may be for processing on demand work loads requested by businesses that require less than a certain maximum of processing power collectively possessed by the nodes in the nodegroup. In addition, further logic enables a system administrator, for example, to assign 320 each of the nodes within a nodegroup with a nodetype in order to uniquely identify a particular node among nodes in the nodegroup. Assigning 320 nodetypes may, for example, be a useful parameter field for populating with a value to uniquely identify a particular node in a nodegroup for undertaking, that is, for balancing purposes, of a particular work load percent requested to be performed by the nodegroup.

Moving down the flowchart 300, FIG. 3 depicts receiving 330 a request by a configuration manager server. The configuration manager server is associated, for example, with a system administrator's computer system charged with configuring a dynamic cluster with members, which include one or more nodegroups and their associated processes in response to user's request communicated to the configuration manager by network communication. The request, itself, from a user's perspective is a request for access and use, for example, of a web service provider's many powerful computer systems and processes. From the configuration manager server's perspective, enabling logic interprets the user's request as instructions for an efficient use and balancing of its many computer systems and processes by creating a dynamic cluster with at least one dynamic cluster member to process the underlying work load associated with the user's request.

Continuing down the flowchart 300, FIG. 3 further depicts parameterizing 340 a dynamic cluster server template associated with the configuration manager server. Before parameterizing 340 a dynamic cluster server template, however, two further steps, namely gathering 350 the configuration files from nodes and storing 360 the nodes' gathered configuration files in a centralized memory location easily accessible for parameterizing 340 are in order. That is, the gathering 350 and storing 360 steps can be thought of as pre-configuration steps for the parameterizing 340 that may be performed by a system administrator. After the gathering 350 and storing 360, parameterizing 340 of the dynamic cluster server template swiftly occurs based on these centrally gathered and stored configuration files for the nodes, having processes, rather than requiring the parameterizing 340 to locate the configuration files for each of the processes on the nodes for parameterization. As previously mentioned, but worth repeating, the resulting parameters may include parameters for nodetypes of nodes within a nodegroup, that was made possible by the pre-configuration step of assigning 320 nodetypes to nodes within a nodegroup.

The flowchart 300 continues by populating 370 the parameters of the parameterized dynamic cluster server template with values identifying nodes in one or more nodegroups that will eventually be cluster members in the dynamic cluster to be created to balance the work load needing to be performed in accordance with the user's request. After the populating 370, the flowchart 300 then depicts instantiating 380 a process associated with a node from the dynamic cluster server template, which is how the configuration manager server informs the processes associated with nodes that they are cluster members of a dynamic cluster configured to perform, in a balanced fashion, the work load associated with the user's request.

The flowchart 300 culminates with a decision block 385 querying if altering in the population of the parameters of the dynamic cluster server template is desired. If no, then the instantiating 380 remains as indicated by keeping 393 the configured dynamic cluster member in the dynamic cluster. If yes, however, then re-instantiating 390 of another process associated with one of the nodes within a nodegroup occurs after a system administrator, for example, utilizes enabling logic associated with the populating 370 and shown by connector 395 to decide which parameters of the parameterized dynamic cluster server template should be populated with values and/or with what kind of values. As a result, instantiating 380 a process associated with one of the nodes from the dynamic cluster server template occurs to effectuate the re-populated dynamic cluster server template.

At this point, having discussed systems and methods, it is useful to discuss the achieved advantages. In particular, configuring and creation of dynamic clusters significantly reduces the time, and hence cost, requirements as compared to prior solutions, such as configuring and creating static clusters. That is, the disclosed methods and systems provide a system administrator with a “fast pass” for configuring clusters at run time by middleware server software. In addition, although not disclosed herein, manageability of these dynamic clusters is similarly eased because autonomic management of cluster membership is made possible. In short, the tedious steps of statically creating a cluster's members and placing the cluster on each node, i.e., member, in the created static cluster is removed because the dynamic cluster is linked to a physical machine that can be decided at run time.

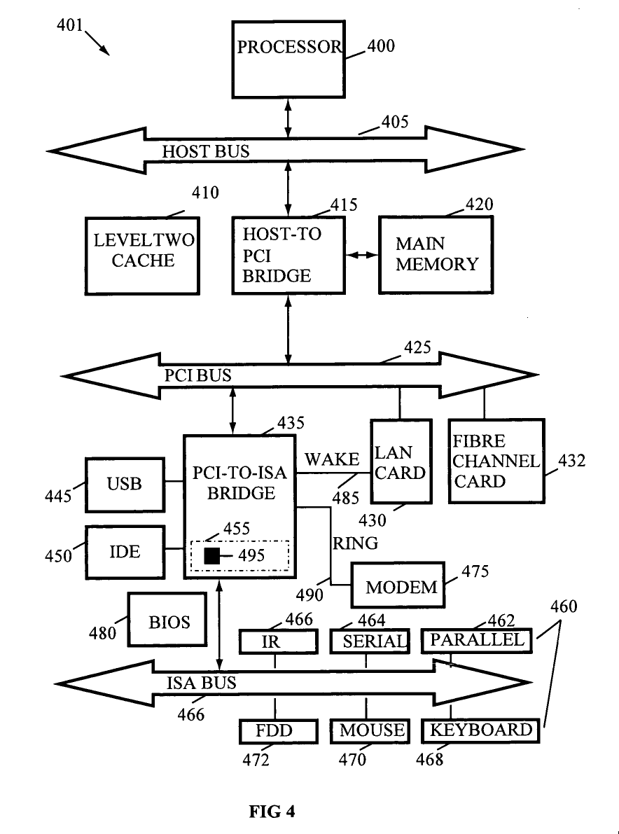

FIG. 4 illustrates information handling system 401 which is a simplified example of a computer system capable of performing the operations described herein. Computer system 401 includes processor 400 which is coupled to host bus 405. A level two (L2) cache memory 510 is also coupled to the host bus 405. Host-to-PCI bridge 415 is coupled to main memory 420, includes cache memory and main memory control functions, and provides bus control to handle transfers among PCI bus 425, processor 400, L2 cache 410, main memory 420, and host bus 405. PCI bus 425 provides an interface for a variety of devices including, for example, LAN card 430. PCI-to-ISA bridge 435 provides bus control to handle transfers between PCI bus 425 and ISA bus 440, universal serial bus (USB) functionality 445, IDE device functionality 450, power management functionality 455, and can include other functional elements not shown, such as a real-time clock (RTC), DMA control, interrupt support, and system management bus support. Peripheral devices and input/output (I/O) devices can be attached to various interfaces 460 (e.g., parallel interface 462, serial interface 464, infrared (IR) interface 466, keyboard interface 468, mouse interface 470, fixed disk (HDD) 472, removable storage device 474) coupled to ISA bus 440. Alternatively, many I/O devices can be accommodated by a super I/O controller (not shown) attached to ISA bus 440.

BIOS 480 is coupled to ISA bus 440, and incorporates the necessary processor executable code for a variety of low-level system functions and system boot functions. BIOS 480 can be stored in any computer readable medium, including magnetic storage media, optical storage media, flash memory, random access memory, read only memory, and communications media conveying signals encoding the instructions (e.g., signals from a network). In order to attach computer system 401 to another computer system to copy files over a network, LAN card 430 is coupled to PCI bus 425 and to PCI-to-ISA bridge 435. Similarly, to connect computer system 401 to an ISP to connect to the Internet using a telephone line connection, modem 475 is connected to serial port 464 and PCI-to-ISA Bridge 435.

While the computer system described in FIG. 4 is capable of executing the invention described herein, this computer system is simply one example of a computer system. Those skilled in the art will appreciate that many other computer system designs are capable of performing the invention described herein.

Another embodiment of the invention is implemented as a program product for use with a computer system such as, for example, the systems 100 and 200 shown in FIG. 1 and FIG. 2. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

While the foregoing is directed to example embodiments of the disclosed invention, other and further embodiments of the invention may be devised without departing from the basic scope thereof, and the scope thereof is determined by the claims that follow.

1. A method for clustering, the method comprising:
receiving, by a configuration manager server, a request to create a dynamic cluster member for a dynamic cluster, wherein the request is for work load balancing and the dynamic cluster member is a process;
parameterizing, by the configuration manager server, to create parameters for a dynamic cluster server template based on configuration files of nodes within a nodegroup, wherein the configuration files and the dynamic cluster server template are stored in a central location associated with the configuration manager server;
populating, by the configuration manager server, the parameters of the dynamic cluster server template with values associated with the nodes; and
instantiating, by the configuration manager server, the process, associated with at least one of the nodes, from the dynamic cluster server template after the populating, thereby, creating the dynamic cluster member.

2. The method of claim 1, further comprising gathering, by configuration manager server, the configuration files of the nodes before the parameterizing.

3. The method of claim 1, further comprising storing, by the configuration manager server, the configuration files of the nodes' before the parameterizing.

4. The method of claim 1, further comprising configuring processes associated with the nodes to be within a nodegroup before the parameterizing.

5. The method of claim 1, further comprising assigning each of the nodes with nodetypes before the parameterizing.

6. The method of claim 1, further comprising re-instantiating another process, associated with at least one of the nodes, from the dynamic cluster server template after altering the parameters of the dynamic cluster server template to be populated by the populating.

7. The method of claim 1, wherein the method is for an on-demand environment.

8. A system for clustering, the system comprising:
a receiver in communication with a configuration manager server for receiving a request to create a dynamic cluster member for a dynamic cluster, wherein the request is for work load balancing and the dynamic cluster member is a process;
memory in a centralized location in communication with the configuration manager server;
a dynamic cluster server template stored in the memory and associated with the configuration manager server;
a parameterization module in communication with the configuration manager server for parameterizing the dynamic cluster server template based on configuration files of nodes within a nodegroup, wherein the configuration files are stored in the memory;
a population module in communication with the configuration manager server for populating, the parameters of the dynamic cluster server template with values associated with the nodes; and
an instantiation module in communication with the configuration manager server for instantiating, by the configuration manager server, the process, associated with at least one of the nodes, from the dynamic cluster server template after execution by the population module, whereby, the dynamic cluster member is created.

9. The system of claim 8, further comprising a collection module associated with the configuration manager server for gathering the configuration files of the nodes before execution by the parameterization module.

10. The system of claim 8, further comprising a storage module associated with the configuration manager server for storing the configuration files of the nodes in the memory before execution by the parameterization module.

11. The system of claim 8, further comprising a configuration module associated with the configuration manager server for configuring processes, associated the nodes, to be within a nodegroup before execution by the parameterization module.

12. The system of claim 8, further comprising an assignment module associated with the configuration manager server for assigning each of the nodes with nodetypes before execution by the parameterization module.

13. The system of claim 8, further comprising an update module associated with the configuration manager server for re-instantiating another process, associated with at least one of the nodes, from the dynamic cluster server template after altering the parameters of the dynamic cluster server template to be populated by the population module due.

14. The system of claim 8, wherein the system is for an on-demand environment.

15. A machine-accessible medium containing instructions, which when executed by a machine, cause the machine to perform operations for clustering, comprising:
receiving, by a configuration manager server, a request to create a dynamic cluster member for a dynamic cluster, wherein the request is for work load balancing and the dynamic cluster member is a process;
parameterizing, by the configuration manager server, to create parameters for a dynamic cluster server template based on configuration files of nodes within a nodegroup, wherein the configuration files and the dynamic cluster server template are stored in a central location associated with the configuration manager server;
populating, by the configuration manager server, the parameters of the dynamic cluster server template with values associated with the nodes; and
instantiating, by the configuration manager server, the process, associated with at least one of the nodes, from the dynamic cluster server template after the populating, thereby, creating the dynamic cluster member.

16. The machine-accessible medium of claim 15, wherein the instructions further comprise operations for gathering and storing, by configuration manager server, the configuration files of the nodes before executing the instructions for parameterizing.

17. The machine-accessible medium of claim 15, wherein the instructions further comprise operations for configuring processes associated with the nodes to be within a nodegroup before executing the instructions for parameterizing.

18. The machine-accessible medium of claim 15, wherein the instructions further comprise operations for assigning each of the nodes with nodetypes before executing the instructions for parameterizing.

19. The machine-accessible medium of claim 15, wherein the instructions further comprise operations for re-instantiating another process, associated with at least one of the nodes, from the dynamic cluster server template after executing instructions for performing operations for altering the parameters of the dynamic cluster server template to be populated by re-executing the instructions for populating.

20. The machine-accessible medium of claim 15, wherein the instructions are for execution in an on-demand environment.
